(19) United States
(12) Patent Application Publication
(10) Pub. No.: US 2014/0228120 A1
(43) Pub. Date: Aug. 14, 2014

(54) INTERACTIVE IMAGE DISPLAY METHOD AND INTERACTIVE DEVICE

(71) Applicant: National Taiwan Normal University, Taipei City (TW)

(72) Inventors: Jon-Chao HONG, Taipei City (TW); Ming-Yueh HWANG, Taipei City (TW)

(73) Assignee: National Taiwan Normal University, Taipei City (TW)

(21) Appl. No.: 14/074,124

(22) Filed: Nov. 7, 2013

(30) Foreign Application Priority Data
Feb. 8, 2013 (TW) 102105260

(51) Int. Cl. A63F 13/20

(52) U.S. Cl. CPC A63F 13/06
USPC 463/35; 463/30

(57) ABSTRACT

An interactive image display method is to be performed by an interactive device and includes steps of rendering a first interactive image that has a background graphic image overlaid with an overlaying graphic image in a manner that the background graphic image is hidden from view by the overlaying graphic image, generating a triggering instruction in response to user operation, in response to receipt of the triggering instruction, rendering a second interactive image in which a portion of the background graphic image is revealed, and after a predetermined time has elapsed subsequent to receipt of the triggering instruction, rendering a third interactive image in which the background graphic image is hidden from view by the overlaying graphic image.

### CROSS-REFERENCE TO RELATED APPLICATION

This application claims priority of Taiwanese Patent Application No. 102105260, filed on Feb. 8, 2013.

### BACKGROUND OF THE INVENTION

1. Field of the Invention

The present invention relates to an interactive image display method and an interactive device, more particularly to an interactive image display method and an interactive device which may simulate a blowing action or a sweeping action.

2. Description of the Related Art

Interactive image display has been broadly adopted in a modern electronic device. For example, various kinds of interactive simulation games may be played on a portable electronic device for educational and entertainment purposes. Specifically, a conventional archaeology game associated with archaeological field survey in combination with a tablet computer that has audio and video features may provide an immersive experience for a user, so as to promote learning efficiency and user acceptance.

However, the conventional archaeology game only provides virtual tools, such as a brush and a shovel, to be used by the user for simulating a digging action, and lacks more delicate interactive effects, such as blowing actions and sweeping actions. Furthermore, an interactive image of the conventional archaeology game displayed on the tablet computer is relatively unrealistic, and may not simulate a situation where a virtual artifact is hidden from view once again by virtual sand or virtual dirt after a period of time has elapsed subsequent to digging up the virtual artifact.

### SUMMARY OF THE INVENTION

Therefore, an object of the present invention is to provide an interactive image display method which allows a user to simulate blowing and sweeping actions so as to provide a more realistic interactive experience.

Accordingly, the interactive image display method of the present invention is to be performed by an interactive device that includes an input module, a memory module, a processing module and a display module. The memory module stores an overlaying graphic image and a background graphic image. The interactive image display method comprises steps of:

(a) rendering, using the processing module, a first interactive image that has the background graphic image overlaid with the overlaying graphic image in a manner that the background graphic image is hidden from view by the overlaying graphic image when the first interactive image is displayed on a screen of the display module;

(b) generating, using the input module, a triggering instruction in response to user operation;

(c) in response to receipt of the triggering instruction from the input module, rendering, using the processing module, a second interactive image in which a portion of the background graphic image hidden from view by the overlaying graphic image in the first interactive image is revealed when the second interactive image is displayed on the screen of the display module; and

(d) after a predetermined time has elapsed subsequent to receipt of the triggering instruction, rendering, using the processing module, a third interactive image that has the background graphic image overlaid with the overlaying graphic image in a manner that the background graphic image is hidden from view by the overlaying graphic image when the third interactive image is displayed on the screen of the display module.

Another object of the present invention is to provide an interactive device which allows a user to simulate blowing and sweeping actions so as to provide a more realistic interactive experience.

Accordingly, the interactive device of the present invention comprises an input module, a memory module, a display module, and a processing module coupled to the input module, the memory module and the display module. The memory module stores an overlaying graphic image and a background graphic image. The processing module renders a first interactive image that has the background graphic image overlaid with the overlaying graphic image in a manner that the background graphic image is hidden from view by the overlaying graphic image when the first interactive image is displayed on a screen of the display module. The input module generates a triggering instruction in response to user operation. In response to receipt of the triggering instruction from the input module, the processing module renders a second interactive image in which a portion of the background graphic image hidden from view by the overlaying graphic image in the first interactive image is revealed when the second interactive image is displayed on the screen of the display module. After a predetermined time has elapsed subsequent to receipt of the triggering instruction, the processing module renders a third interactive image that has the background graphic image overlaid with the overlaying graphic image in a manner that the background graphic image is hidden from view by the overlaying graphic image when the third interactive image is displayed on the screen of the display module.

An effect of the present invention resides in that, by rendering the second interactive image in which a portion of the background graphic image hidden from view by the overlaying graphic image in the first interactive image is revealed, and by rendering the third interactive image that has the background graphic image overlaid with the overlaying graphic image in a manner that the background graphic image is hidden from view by the overlaying graphic image, a more delicate animation effect which simulates sweeping and/or blowing actions may be achieved.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram illustrating a preferred embodiment of the interactive device of the present invention;

FIG. 2 is a schematic diagram of a second interactive image illustrating that a portion of a background graphic image is revealed in response to receipt of a triggering instruction;

FIG. 3 is a flow chart illustrating a first preferred embodiment of an interactive image display method of the present invention; and

FIG. 4 is a flow chart illustrating a second preferred embodiment of the interactive image display method of the present invention.

### DETAILED DESCRIPTION OF THE PREFERRED EMBODIMENTS

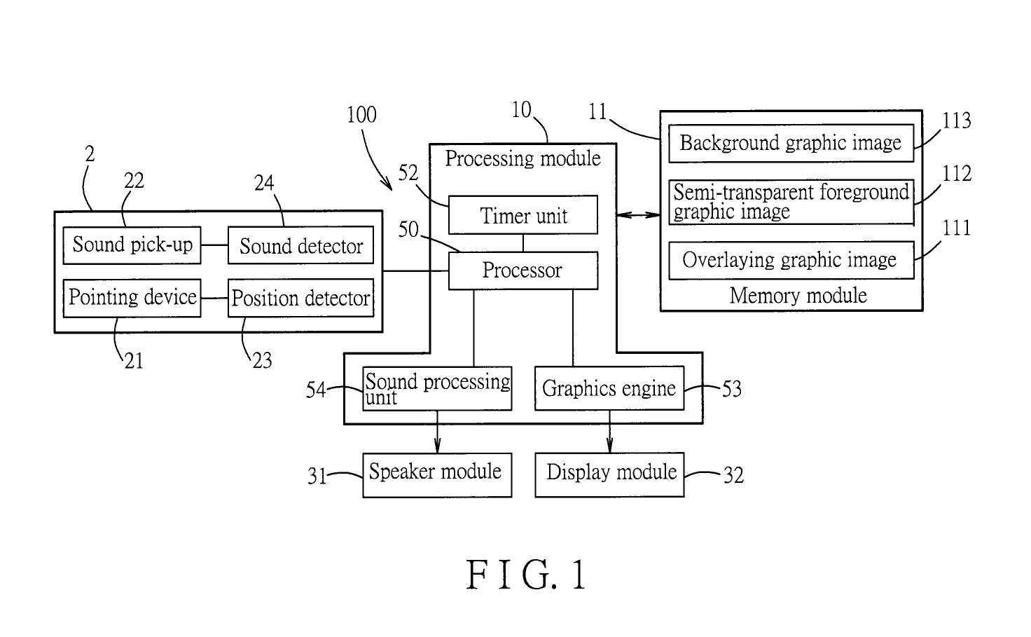

Referring to FIG. 1, a preferred embodiment of an interactive device 100 according to the present invention is illustrated. The interactive device 100 comprises an input module 2, a processing module 10, a memory module 11, and a display module 32. In this embodiment, the interactive device 100 is a tablet computer which allows a user to play an interactive game that is run on the tablet computer. However, the interactive device 100 is not limited to the tablet computer, and may be one of a server, a personal computer, a notebook computer, an ultrabook, a netbook, an All-in-One computer, a handheld computer, an embedded computer, and so forth.

The input module 2 includes a pointing device 21, a position detector 23 coupled to the pointing device 21 and the processing module 10, a sound pick-up 22, and a sound detector 24 coupled to the processing module 10 and the sound pick-up 22. The processing module 10 includes a processor 50, a timer unit 52, a graphics engine 53, and a sound processing unit 54. The interactive device 100 further comprises a speaker module 31 coupled electrically to the sound processing unit 54.

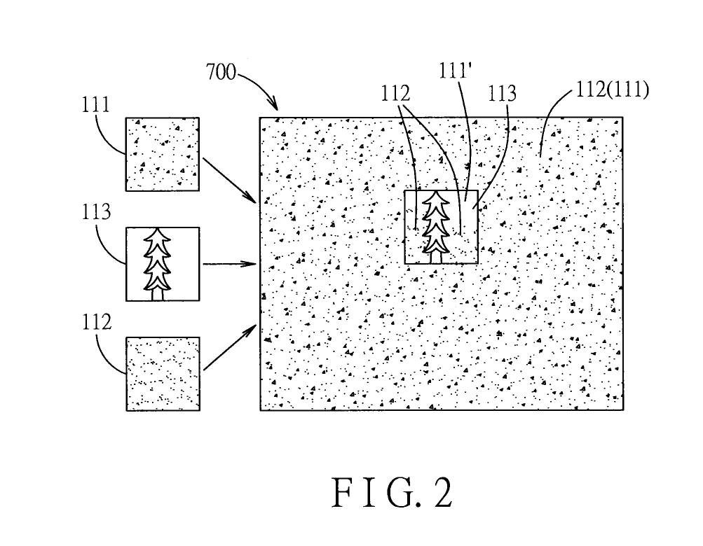

The memory module 11 stores an overlaying graphic image 111 which represents a natural material, a semi-transparent foreground graphic image 112, and a background graphic image 113 which is to be overlaid with the overlaying graphic image 111. When an interactive image display method of the present invention is performed by the interactive device 100, the processor 50 renders an interactive image 700, such as that illustrated in FIG. 2, to be displayed on a screen of the display module 32. In this embodiment, sand is given as an example for the natural material of the overlaying graphic image 111. However, other materials, such as fallen leaves or water, may be adopted as the natural material of the overlaying graphic image 111. The background graphic image 113 represents a to-be-explored object, such as an image of an archaeological artifact or a piece of treasure. The semi-transparent foreground graphic image 112 is overlaid upon the overlaying graphic image 113, and represents bits of sand. However, the semi-transparent foreground graphic image 112 may also represent other natural subtle trails and water marks in other configurations of the preferred embodiment.

In the interactive image display method of the present invention, the input module 2 is provided to generate a triggering instruction in response to user operation, such as a touching action or a blowing action. In response to receipt of the triggering instruction from the input module 2, the processor 50 renders an area 111′ of the overlaying graphic image 111 transparent, and the graphics engine 53, by means of the MPEG4 Sprite technique, generates an animation image to be rendered at a position of the area 111′ of the overlaying graphic image 111, such that the background graphic image 113 may be gradually revealed. The processor 50 enables the timer unit 52 to count down a predetermined time subsequent to receipt of the triggering instruction. After the predetermined time has elapsed, the processor 50 renders the area 111′ of the overlaying graphic image non-transparent 111 (i.e., having a non-transparent attribute), and the graphics engine 53, by means of the MPEG4 Sprite technique, generates an animation image to be rendered at the position of the area 111′ of the overlaying graphic image 111, such that the background graphic image 113 may be gradually hidden. At the same time, the sound processing unit 54 is enabled by the processor 50 to generate a corresponding sound effect signal according to the triggering instruction in response to one of the touching action and the blowing action, so as to drive the speaker module 31. In this way, the user may play the interactive game by means of the display module 32 and the speaker module 31.

A first preferred embodiment of the interactive image display method according to the present invention is implemented in a touch control manner by means of the pointing device 21 and the position detector 23. A second preferred embodiment of the interactive image display method according to the present invention is implemented in an audio control manner by means of the sound pick-up 22 and the sound detector 24.

Referring to FIG. 1 and FIG. 2, the first preferred embodiment of the interactive image display method is to be performed by the interactive device 100, in which the pointing device 21 (e.g., a touch panel) generates a position signal indicating position of a pointing event on the screen, and the position detector 23 generates the triggering instruction corresponding to the position of the pointing event on the screen. In response to receipt of the triggering instruction from the position detector 23, the processor 50 determines a portion of the background graphic image that is to be revealed in the interactive image 700 (i.e., the area 111′ of the overlaying graphic image 111 to be rendered transparent) based on the triggering instruction. For example, the portion that is to be revealed may be a rectangular area having predetermined dimensions and being proximate to the position of the pointing event on the screen.

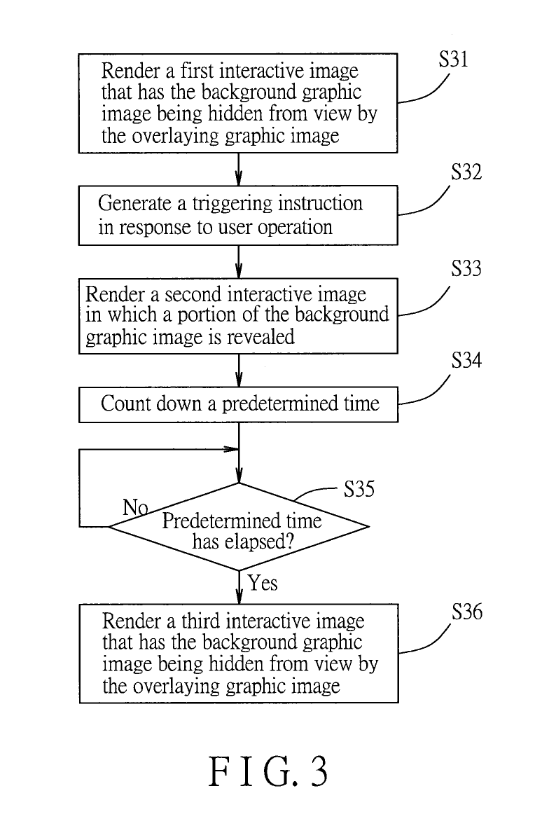

Referring to FIG. 3 in combination with FIG. 1 and FIG. 2, a flow chart of the first preferred embodiment of the interactive image display method is illustrated.

In step S31, the processor 50 renders a first interactive image that has the background graphic image 113 overlaid with the overlaying graphic image 111, which has a non-transparent attribute, and that has the overlaying graphic image 111 overlaid with the semi-transparent foreground graphic image 112, in a manner that the background graphic image 113 is hidden from view by the overlaying graphic image 111 when the first interactive image is displayed on the screen of the display module 32. In the first interactive image, only the overlaying graphic image 111 overlaid with the semi-transparent foreground graphic image 112 may be viewed by the user.

In step S32, the input module 2 generates a triggering instruction in response to user operation. Specifically, the pointing device 21 generates a position signal indicating position of a pointing event on the screen, and the position detector 23 generates the triggering instruction corresponding to the position of the pointing event on the screen.

In step S33, in response to receipt of the triggering instruction from the position detector 23, the processor 50 renders a second interactive image in which a portion of the background graphic image 113 hidden from view by the overlaying graphic image 111 in the first interactive image is revealed when the second interactive image is displayed on the screen of the display module 32. Specifically, the processor 50 renders an area 111′ of the overlaying graphic image 111 in the second interactive image transparent, so that the portion of the background graphic image 113 hidden from view by the overlaying graphic image 111 in the first interactive image is revealed when the second interactive image is displayed on the screen of the display module 32. More specifically, the processor 50 determines the portion of the background graphic image 113 that is to be revealed in the second interactive image based on the triggering instruction.

In step S34, the processor 50 enables the timer unit 52 to count down a predetermined time subsequent to receipt of the triggering instruction.

In step S35, the processor 50 determines whether the predetermined time has elapsed.

In step S36, after the predetermined time has elapsed subsequent to receipt of the triggering instruction, the processor 50 renders a third interactive image that has the background graphic image 113 overlaid with the overlaying graphic image 111, which has a non-transparent attribute, in a manner that the background graphic image 113 is hidden from view by the overlaying graphic image 111 when the third interactive image is displayed on the screen of the display module 32.

Program codes associated with the position of the pointing event on the screen as illustrated in step S33 are listed hereinafter.

(void)ccTouchesMoved:(NSSet *)touches
withEvent:(UIEvent *)event
{
UITouch *touch = [touches anyObject];
CGPoint location = [touch locationInView: [touch
view]];
CGPoint curPosition = [[CCDirector sharedDirector]
convertToGL:location];
burnSprite.position = CGPointMake(curPosition.x,
curPosition.y);
}

The second preferred embodiment of the interactive image display method is similar to the first preferred embodiment and is to be performed by the interactive device 100, in which the sound pick-up 22 detects a blowing sound resulting from the blowing action made by the user and generates an audio signal associated with the blowing sound, and the sound detector 24 determines whether or not to generate the triggering instruction based on the audio signal generated by the sound pick-up 22. In response to receipt of the triggering instruction from the sound detector 24, the processor 50 renders an area 111′ of the overlaying graphic image 111 transparent. In this embodiment, the position of the area 111′ of the overlaying graphic image 111 on the screen is preset.

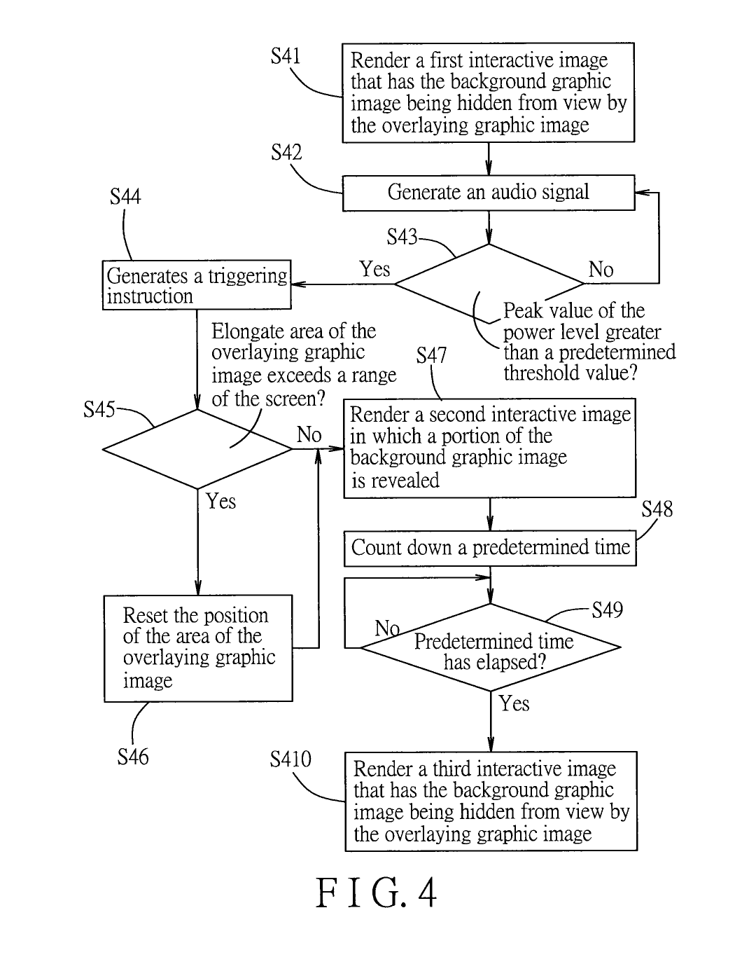

Referring to FIG. 4 in combination with FIG. 1 and FIG. 2, a flow chart of the second preferred embodiment of the interactive image display method is illustrated.

In step S41, the processor 50 renders a first interactive image that has the background graphic image 113 overlaid with the overlaying graphic image ill, which has a non-transparent attribute, and that has the overlaying graphic image 111 overlaid with the semi-transparent foreground graphic image 112, in a manner that the background graphic image 113 is hidden from view by the overlaying graphic image 111 when the first interactive image is displayed on the screen of the display module 32. In the first interactive image, only the overlaying graphic image 111 overlaid with the semi-transparent foreground graphic image 112 may be viewed by the user.

In step S42, the sound pick-up 22 generates the audio signal, and the sound detector 24 processes the audio signal to obtain a to-be-measured signal. Processing of the audio signal includes performing moving average and filtering upon the audio signal while taking into account a peak value of a power level (dB) of the audio signal.

In step S43, the sound detector 24 compares the peak value of the power level of the to-be-measured signal with a predetermined threshold value. The flow goes back to step S42 when it is determined in step S43 that the peak value of the power level of the to-be-measured signal is not greater than the predetermined value.

In step S44, the sound detector 24 generates the triggering instruction when the peak value of the power level of the to-be-measured signal is greater than the predetermined value.

In other words, steps S42 to S44 are sub-steps of determining, using the sound detector 24, whether or not to generate the triggering instruction based on the audio signal generated by the sound pick-up 22.

It may be found from an experimental result that the peak value of the power level of the audio signal generated by the sound pick-up 22 in response to the user's blowing action is greater than 0.75 dB, and a peak value of a power level of an ordinary speaking sound ranges from 0.25 dB to 0.5 dB. Therefore, in the second preferred embodiment of the interactive image display method, 0.75 dB is adopted as the predetermined threshold value. The triggering instruction is generated when the peak value of the power level of the to-be-measured signal is greater than 0.75 dB. Otherwise, the processor 50 is not triggered by the sound detector 24.

In step 45, for the purpose of simulating an elongate trail along a direction of the blowing action, the processor 50 further sets a continuous block according to the triggering instruction that represents a continuous blowing action. An area 111′ of the overlaying graphic image 111 which is to be rendered transparent has an elongate shape, and a position of the area 111′ of the overlaying graphic image 111 is preset. The processor 50, based on the continuous block set thereby, determines whether the elongate area 111′ of the overlaying graphic image 111 exceeds a range of the screen of the display module 32.

In step S46, when it is determined in step S45 that the elongate area 111′ of the overlaying graphic image 111 exceeds the range of the screen of the display module 32, the processor 50 resets the position of the area 111′ of the overlaying graphic image 111, so that the area 111′ of the overlaying graphic image 111 will not exceed the range of the screen of the display module 32, and the flow proceeds to step S47.

In step S47, in response to receipt of the triggering instruction from the sound detector 24, the processor 50 renders a second interactive image in which a portion of the background graphic image 113 hidden from view by the overlaying graphic image 111 in the first interactive image is revealed when the second interactive image is displayed on the screen of the display module 32. Specifically, the processor 50 renders the area 111′ of the overlaying graphic image 111 in the second interactive image transparent, so that the portion of the background graphic image 113 hidden from view by the overlaying graphic image 111 in the first interactive image is revealed when the second interactive image is displayed on the screen of the display module 32.

In step S48, the processor 50 enables the timer unit 52 to count down a predetermined time subsequent to receipt of the triggering instruction.

In step S49, the processor 50 determines whether the predetermined time has elapsed.

In step S410, after the predetermined time has elapsed subsequent to receipt of the triggering instruction, the processor 50 renders a third interactive image that has the background graphic image 113 overlaid with the overlaying graphic image 111, which has a non-transparent attribute, in a manner that the background graphic image 113 is hidden from view by the overlaying graphic image 111 when the third interactive image is displayed on the screen of the display module 32.

It is noted that both of the pointing device 21 and the sound pick-up 22 may be adopted simultaneously when the interactive image display method is performed by the interactive device 100. That is to say, the processor 50 may render the area 111′ of the overlaying graphic image 111 transparent with reference to a respective one of the position signal generated by the pointing device 21 and the audio signal generated by the sound pick-up 22.

Moreover, when the hardware performance is sufficient, multiple layers of graphic images may be adopted while rendering the interactive image, and at least one of the graphic images is selected to be rendered transparent. By means of calculating variations in RGB components of the interactive image using image processing techniques, a position of an area of said at least one of the graphic images that has been rendered transparent may be determined. Further, a visual effect of the to-be-explored object being covered by sand or dirt may be implemented by means of the particle system technique.

The memory module 11 of the interactive device 100 further stores program instructions which, when executed by the interactive device 100, cause the display module 32 to display the interactive image 700 as shown in FIG. 2, and cause the interactive device 100 to perform the interactive image display method as illustrated in FIG. 3 and FIG. 4.

To sum up, the input module 2 generates a triggering instruction in response to one of the touching action and the blowing action, the processor 50 renders the area 111′ of the overlaying graphic image 111 transparent such that the portion of the background graphic image 113 is revealed, and after the predetermined time has elapsed, the processor 50 renders the area 111′ of the overlaying graphic image 111 non-transparent such that the portion of the background graphic image 113 is hidden once again, so as to simulate the to-be-explored object being covered by the natural material, such as sand, fallen leaves, or water. A more delicate animation effect of sweeping action and/or blowing action may be developed. Therefore, users may have a more realistic interactive image display experience while playing interactive games.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An interactive image display method to be performed by an interactive device that includes an input module, a memory module, a processing module and a display module, the memory module storing an overlaying graphic image and a background graphic image, said interactive image display method comprising steps of:
(a) rendering, using the processing module, a first interactive image that has the background graphic image overlaid with the overlaying graphic image in a manner that the background graphic image is hidden from view by the overlaying graphic image when the first interactive image is displayed on a screen of the display module;
(b) generating, using the input module, a triggering instruction in response to user operation;
(c) in response to receipt of the triggering instruction from the input module, rendering, using the processing module, a second interactive image in which a portion of the background graphic image hidden from view by the overlaying graphic image in the first interactive image is revealed when the second interactive image is displayed on the screen of the display module; and
(d) after a predetermined time has elapsed subsequent to receipt of the triggering instruction, rendering, using the processing module, a third interactive image that has the background graphic image overlaid with the overlaying graphic image in a manner that the background graphic image is hidden from view by the overlaying graphic image when the third interactive image is displayed on the screen of the display module.

2. The interactive image display method as claimed in claim 1, wherein, in each of the first interactive image and the third interactive image, the overlaying graphic image has a non-transparent attribute such that the background graphic image is hidden from view when a corresponding one of the first interactive image and the third interactive image is displayed on the screen of the display module.

3. The interactive image display method as claimed in claim 1, wherein, in step (c), the processing module renders an area of the overlaying graphic image in the second interactive image transparent, so that the portion of the background graphic image hidden from view by the overlaying graphic image in the first interactive image is revealed when the second interactive image is displayed on the screen of the display module.

4. The interactive image display method as claimed in claim 1, the input module including a pointing device, and a position detector coupled to the pointing device and the processing module,
wherein step (b) includes
generating, using the pointing device, a position signal indicating position of a pointing event on the screen, and
generating, using the position detector, the triggering instruction corresponding to the position of the pointing event on the screen; and
wherein step (c) includes determining, by the processing module, the portion of the background graphic image that is to be revealed in the second interactive image based on the triggering instruction.

5. The interactive image display method as claimed in claim 1, the input module including a sound pick-up, and a sound detector coupled to the processing module and the sound pick-up, wherein step (b) includes
(b-1) generating an audio signal using the sound pick-up, and
(b-2) determining, using the sound detector, whether or not to generate the triggering instruction based on the audio signal generated by the sound pick-up.

6. The interactive image display method as claimed in claim 5, wherein sub-step (b-2) includes:
processing the audio signal to obtain a to-be-measured signal;
comparing a peak value of a power level of the to-be-measured signal with a predetermined threshold value; and
generating the triggering instruction when the peak value of the power level of the to-be-measured signal is greater than the predetermined value.

7. The interactive image display method as claimed in claim 6, wherein processing of the audio signal includes performing moving average and filtering upon the audio signal while taking into account a peak value of a power level of the audio signal.

8. The interactive image display method as claimed in claim 5, wherein, in step (c), the processing module renders an area of the overlaying graphic image in the second interactive image transparent, so that the portion of the background graphic image hidden from view by the overlaying graphic image in the first interactive image is revealed when the second interactive image is displayed on the screen of the display module.

9. The interactive image display method as claimed in claim 8, wherein, in step (c), a position of the area of the overlaying graphic image on the screen is preset, and the area of the overlaying graphic image has an elongate shape.

10. An interactive device comprising an input module, a memory module, a display module, and a processing module coupled to said input module, said memory module and said display module, wherein:
said memory module stores an overlaying graphic image and a background graphic image;
said processing module renders a first interactive image that has the background graphic image overlaid with the overlaying graphic image in a manner that the background graphic image is hidden from view by the overlaying graphic image when the first interactive image is displayed on a screen of said display module;
said input module generates a triggering instruction in response to user operation;
in response to receipt of the triggering instruction from said input module, said processing module renders a second interactive image in which a portion of the background graphic image hidden from view by the overlaying graphic image in the first interactive image is revealed when the second interactive image is displayed on the screen of said display module; and
after a predetermined time has elapsed subsequent to receipt of the triggering instruction, said processing module renders a third interactive image that has the background graphic image overlaid with the overlaying graphic image in a manner that the background graphic image is hidden from view by the overlaying graphic image when the third interactive image is displayed on the screen of said display module.

11. The interactive device as claimed in claim 10, wherein, in each of the first interactive image and the third interactive image, the overlaying graphic image has a non-transparent attribute such that the background graphic image is hidden from view when a corresponding one of the first interactive image and the third interactive image is displayed on the screen of said display module.

12. The interactive device as claimed in claim 10, wherein said processing module renders an area of the overlaying graphic image in the second interactive image transparent, so that the portion of the background graphic image hidden from view by the overlaying graphic image in the first interactive image is revealed when the second interactive image is displayed on the screen of said display module.

13. The interactive device as claimed in claim 10,
wherein said input module includes a pointing device, and a position detector coupled to said pointing device and said processing module;
wherein said pointing device generates a position signal indicating position of a pointing event on the screen, and said position detector generates the triggering instruction corresponding to the position of the pointing event on the screen; and
wherein said processing module determines the portion of the background graphic image that is to be revealed in the second interactive image based on the triggering instruction.

14. The interactive device as claimed in claim 10,
wherein said input module includes a sound pick-up, and a sound detector coupled to said processing module and said sound pick-up; and
wherein said sound pick-up generates an audio signal, and said sound detector determines whether or not to generate the triggering instruction based on the audio signal generated by said sound pick-up.

15. The interactive device as claimed in claim 14, wherein said sound detector is configured to:
process the audio signal to obtain a to-be-measured signal;
compare a peak value of a power level of the to-be-measured signal with a predetermined threshold value; and
generate the triggering instruction when the peak value of the power level of the to-be-measured signal is greater than the predetermined value.

16. The interactive device as claimed in claim 15, wherein processing of the audio signal includes performing moving average and filtering upon the audio signal while taking into account a peak value of a power level of the audio signal.

17. The interactive image display method as claimed in claim 14, wherein said processing module renders an area of the overlaying graphic image in the second interactive image transparent, so that the portion of the background graphic image hidden from view by the overlaying graphic image in the first interactive image is revealed when the second interactive image is displayed on the screen of said display module.

18. The interactive image display method as claimed in claim 17, wherein a position of the area of the overlaying graphic image on the screen is preset, and the area of the overlaying graphic image has an elongate shape.
